(19) United States
(12) Patent Application Publication
(10) Pub. No.: US 2016/0247284 A1
(43) Pub. Date: Aug. 25, 2016

(54) IMAGE PROCESSOR WITH MULTI-CHANNEL INTERFACE BETWEEN PREPROCESSING LAYER AND ONE OR MORE HIGHER LAYERS

(71) Applicant: LSI Corporation, San Jose, CA (US)

(72) Inventors: Denis V. Zaytsev, Moscow (RU); Stanislav v. Aleshin, Moscow (RU); Alexander B. Kholodenko, Moscow (RU); Ivan L. Mazurenko, Moscow (RU); Denis P. Parkhomemko, Moscow (RU)

(21) Appl. No.: 14/238,356

(22) PCT Filed: Aug. 29, 2013
(86) PCT No.: PCT/US13/57256

§ 371 Date: Feb. 11, 2014

(30) Foreign Application Priority Data
Feb. 28, 2013 (RU) 2013109063

(51) Int. Cl. G06T 7/00; G06T 1/20

(52) U.S. Cl. CPC G06T 7/0051; G06T 1/20; G06T 2207/10028; G06T 2207/10052

(57) ABSTRACT

An image processor comprises image processing circuitry implementing a plurality of processing layers including a preprocessing layer for received image data and one or more higher processing layers coupled to the preprocessing layer. The image processor further comprises a multi-channel interface including at least first and second image data channels arranged in parallel with one another between the preprocessing layer and a given higher processing layer. The first image data channel is configured to carry partial depth information derived from the received image data to the given higher processing layer, and the second image data channel is configured to carry complete preprocessed frames of the received image data from the preprocessing layer to the given higher processing layer. By way of example only, in a given embodiment the partial depth information comprises depth information determined to have at least a specified level of reliability.

### FIELD

The field relates generally to image processing, and more particularly to processing of images such as depth maps and other types of depth images.

### BACKGROUND

Image processing is important in a wide variety of different applications, and such processing may involve multiple images of different types, including two-dimensional (2D) images and three-dimensional (3D) images. For example, a 3D image of a spatial scene may be generated using triangulation based on multiple 2D images captured by respective cameras arranged such that each camera has a different view of the scene. Alternatively, a 3D image can be generated directly using a depth imager such as a structured light (SL) camera or a time of flight (ToF) camera. Multiple images of these and other types may be processed in machine vision applications such as gesture recognition, feature extraction, pattern identification, face detection, object recognition and person or object tracking.

In typical conventional arrangements, raw image data from an image sensor is usually subject to various preprocessing operations. Such preprocessing operations may include, for example, contrast enhancement, histogram equalization, noise reduction, edge highlighting and coordinate space transformation, among many others. The preprocessed image data is then subject to additional processing needed to implement one or more of the above-noted machine vision applications.

### SUMMARY

In one embodiment, an image processor comprises image processing circuitry implementing a plurality of processing layers including a preprocessing layer for received image data and one or more higher processing layers coupled to the preprocessing layer. The image processor further comprises a multi-channel interface including at least first and second image data channels arranged in parallel with one another between the preprocessing layer and a given higher processing layer. The first image data channel is configured to carry partial depth information derived from the received image data to the given higher processing layer, and the second image data channel is configured to carry complete preprocessed frames of the received image data from the preprocessing layer to the given higher processing layer.

By way of example only, in a given embodiment the partial depth information comprises depth information determined to have at least a specified level of reliability. Also, the one or more higher processing layers coupled to the preprocessing layer may comprise a second processing layer coupled to a third processing layer, with the first and second image data channels being arranged in parallel with one another between the preprocessing layer and the third processing layer.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an image processing system comprising an image processor having a preprocessing layer with a multi-channel interface to one or more higher processing layers in one embodiment.

FIGS. 2 and 3 illustrate progressively more detailed views of exemplary processing layers of the image processor of FIG. 1.

FIG. 4 shows another embodiment of an image processing system comprising an image processor implemented in the form of a controller chip having a preprocessing layer and second and third higher processing layers.

### DETAILED DESCRIPTION

Embodiments of the invention will be illustrated herein in conjunction with exemplary image processing systems that include image processors or other types of processing devices that implement a multi-channel interface between a preprocessing layer and one or more higher processing layers. It should be understood, however, that embodiments of the invention are more generally applicable to any image processing system or associated device or technique that can benefit from more efficient interaction between a preprocessing layer and one or more higher processing layers.

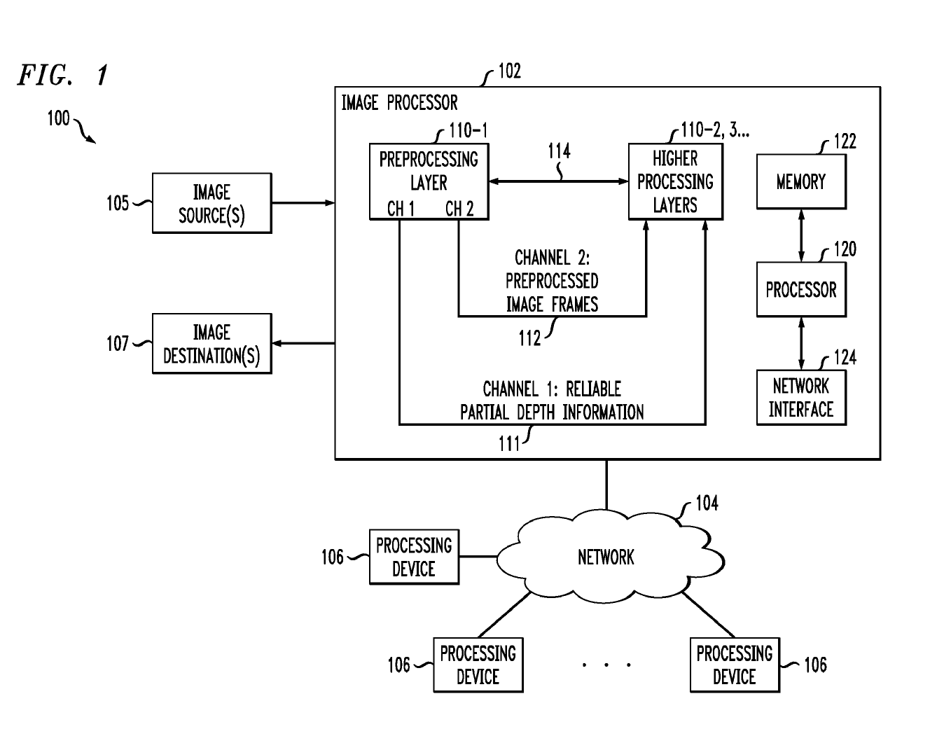

FIG. 1 shows an image processing system 100 in an embodiment of the invention. The image processing system 100 comprises an image processor 102 that receives images from one or more image sources 105 and provides processed images to one or more image destinations 107. The image processor 102 also communicates over a network 104 with a plurality of processing devices 106.

Although the image source(s) 105 and image destination(s) 107 are shown as being separate from the processing devices 106 in FIG. 1, at least a subset of such sources and destinations may be implemented as least in part utilizing one or more of the processing devices 106. Accordingly, images may be provided to the image processor 102 over network 104 for processing from one or more of the processing devices 106. Similarly, processed images may be delivered by the image processor 102 over network 104 to one or more of the processing devices 106. Such processing devices may therefore be viewed as examples of image sources or image destinations.

A given image source may comprise, for example, a 3D imager such as an SL camera or a ToF camera configured to generate depth images, or a 2D imager configured to generate grayscale images, color images, infrared images or other types of 2D images. It is also possible that a single imager or other image source can provide both a depth image and a corresponding 2D image such as a grayscale image, a color image or an infrared image. For example, certain types of existing 3D cameras are able to produce a depth map of a given scene as well as a 2D image of the same scene. Alternatively, a 3D imager providing a depth map of a given scene can be arranged in proximity to a separate high-resolution video camera or other 2D imager providing a 2D image of substantially the same scene.

It is also to be appreciated that a given image source as that term is broadly used herein may represent an image sensor portion of an imager that incorporates at least a portion of the image processor 102. For example, at least one of the one or more image sources 105 may comprise a depth sensor, with the depth sensor being part of an SL camera, a ToF camera or other depth imager that incorporates the image processor 102. Numerous alternative arrangements are possible. For example, another example of an image source is a storage device or server that provides images to the image processor 102 for processing. A given image destination may comprise, for example, one or more display screens of a human-machine interface of a computer or mobile phone, or at least one storage device or server that receives processed images from the image processor 102.

Accordingly, although the image source(s) 105 and image destination(s) 107 are shown as being separate from the image processor 102 in FIG. 1, the image processor 102 may be at least partially combined with at least a subset of the one or more image sources and the one or more image destinations on a common processing device. Thus, for example, a given image source and the image processor 102 may be collectively implemented on the same processing device. Similarly, a given image destination and the image processor 102 may be collectively implemented on the same processing device.

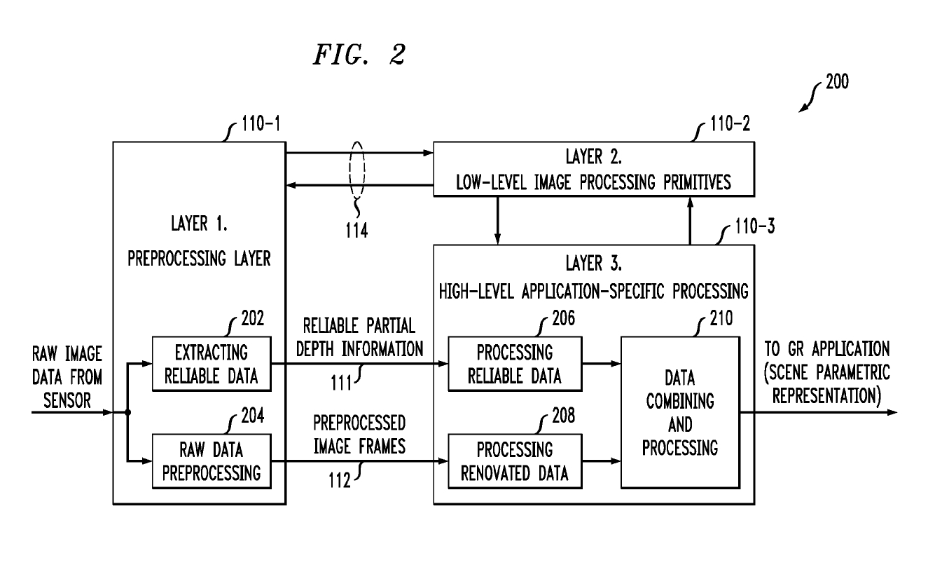

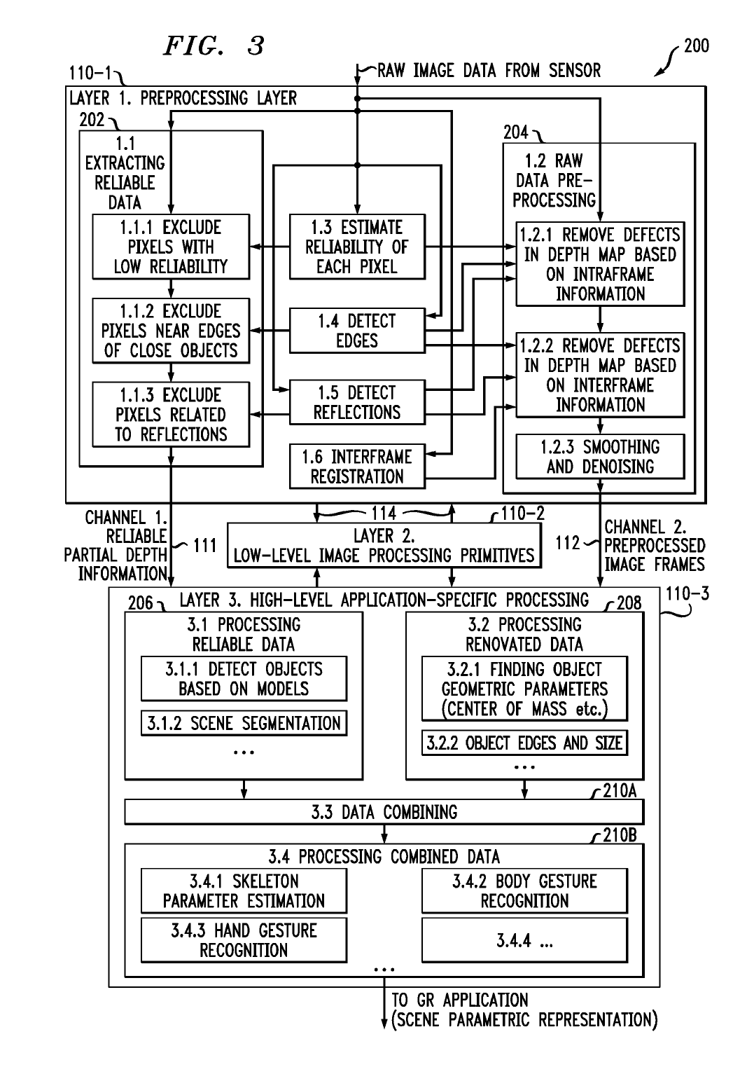

In the present embodiment, the image processor 102 comprises a preprocessing layer 110-1 coupled to multiple higher processing layers denoted 110-2, 110-3 and so on. The preprocessing layer 110-1 and the higher processing layers such as layers 110-2 and 110-3 are collectively referred to herein as processing layers 110. Also, preprocessing layer 110-1 is referred to as Layer 1, and the higher processing layers denoted as respective second and third layers 110-2 and 110-3 are referred to as Layer 2 and Layer 3, respectively. It will be assumed for purposes of the further description to be provided below in conjunction with FIGS. 2 and 3 that the higher processing layers of the image processor 102 comprise only the processing layers 110-2 and 110-3, with it being understood that more than three processing layers 110 may be provided in the image processor 102 in other embodiments. The term “higher” as used in the context of processing layers herein should be understood to encompass any processing layers that receive outputs from a preprocessing layer and thus perform subsequent processing operations of those outputs.

The preprocessing layer 110-1 performs preprocessing operations on received image data from the one or more image sources 105. This received image data in the present embodiment is assumed to comprise raw image data received from a depth sensor, but other types of received image data may be processed in other embodiments.

The image processor 102 further comprises a multi-channel interface comprising at least first and second image data channels 111 and 112 arranged in parallel with one another between the preprocessing layer 110-1 and a given one of the higher processing layers 110-2 and 110-3.

The first image data channel 111 is configured to carry reliable partial depth information derived from the received image data to the given higher processing layer, and the second image data channel 112 is configured to carry complete preprocessed frames of the received image data from the preprocessing layer 110-1 to the given higher processing layer. The partial depth information may comprise, for example, depth information determined in the preprocessing layer 110-1 to have at least a specified level of reliability, although other types of partial depth information may be used in other embodiments. The first and second image data channels are also denoted herein as Channel 1 and Channel 2, respectively, or as CH1 and CH2 in this particular figure.

The term “complete” as used herein in the context of a given preprocessed frame sent over the second image data channel 112 is intended to be broadly construed, and should not be construed as limited to any particular frame arrangement. For example, a variety of different preprocessed frames of different types may be sent over this channel. A given complete preprocessed frame may comprise, for example, a substantially full set of depth information of a depth image as preprocessed by the preprocessing layer 110-1, as contrasted to partial depth information sent over the first image data channel 111.

The particular number of image data channels of the multi-channel interface between the preprocessing layer 110-1 and the given higher processing layer can be varied in other embodiments. Accordingly, the multi-channel interface may comprise more than two image data channels arranged in parallel with one another in other embodiments.

As is illustrated in FIGS. 2 and 3, the first and second image data channels 111 and 112 are more particularly arranged in parallel with one another between the preprocessing layer 110-1 and the third processing layer 110-3. However, in other embodiments, a multi-channel interface comprising a plurality of parallel image data channels may be arranged between the preprocessing layer 110-1 and additional or alternative higher processing layers. The preprocessing layer 110-1 further includes an interface 114 with a higher processing layer other than the one which is coupled via the multi-channel interface 111 and 112. In this embodiment, as will be illustrated in FIGS. 2 and 3, the interface 114 is assumed to be an interface with the second processing layer 110-2. It should be noted in this regard that one or more interface signal lines that are illustrated in the figures as bidirectional may alternatively be unidirectional, and vice versa.

The processing layers 110 may comprise different portions of image processing circuitry of the image processor 102, although a given such processing layer may be implemented as a combination of hardware, firmware and software. The term “layer” as utilized herein is therefore intended to be broadly construed, and may comprise, for example, specialized hardware, processing cores, firmware engines and associated firmware, or general-purpose processing resources and associated software executing on those resources, as well as various combinations of these and other types of image processing circuitry.

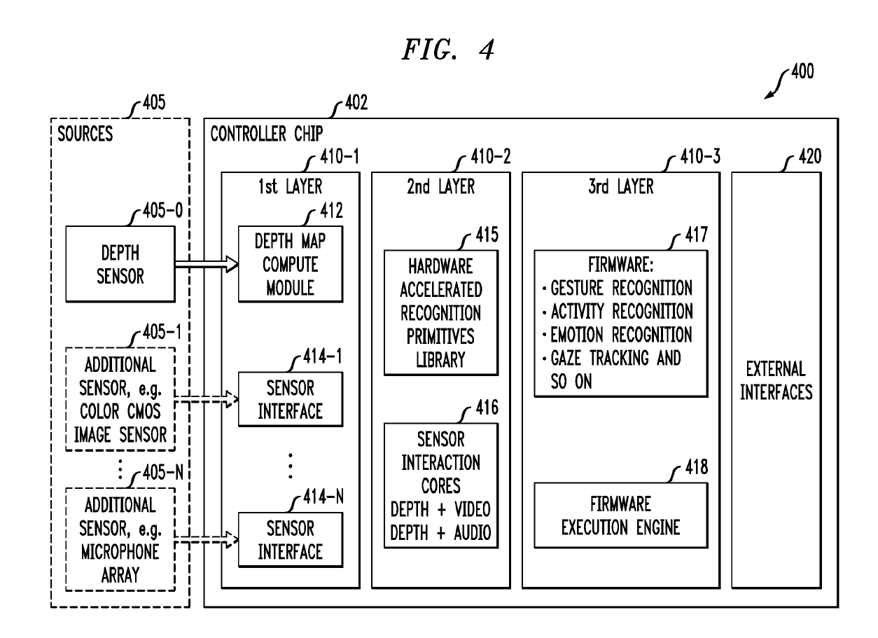

An otherwise conventional image processing integrated circuit or other type of image processing circuitry may be suitably modified to implement at least a portion of one or more of the processing layers 110 of image processor 102, as will be appreciated by those skilled in the art. One possible example of image processing circuitry that may be used in one or more embodiments of the invention is an otherwise conventional graphics processor suitably reconfigured to perform functionality associated with one or more of the processing layers 110. A more detailed example of an image processing circuitry arrangement of this type in which the graphics processor comprises a controller integrated circuit of an image processing system will be described in detail in conjunction with FIG. 4.

The processing devices 106 may comprise, for example, computers, mobile phones, servers or storage devices, in any combination. One or more such devices also may include, for example, display screens or other user interfaces that are utilized to present images generated by the image processor 102. The processing devices 106 may therefore comprise a wide variety of different destination devices that are configured to receive processed image streams or other types of output information from the image processor 102 over the network 104, including by way of example at least one server or storage device that receives such output information from the image processor 102.

Although shown as being separate from the processing devices 106 in the present embodiment, the image processor 102 may be at least partially combined with one or more of the processing devices 106. Thus, for example, the image processor 102 may be implemented at least in part using a given one of the processing devices 106. By way of example, a computer or mobile phone may be configured to incorporate the image processor 102 and possibly a given image source. The image source(s) 105 may therefore comprise cameras or other imagers associated with a computer, mobile phone or other processing device. As indicated previously, the image processor 102 may be at least partially combined with one or more image sources or image destinations on a common processing device.

The image processor 102 in the present embodiment is assumed to be implemented using at least one processing device and comprises a processor 120 coupled to a memory 122. The processor 120 executes software code stored in the memory 122 in order to control the performance of image processing operations. The image processor 102 also comprises a network interface 124 that supports communication over network 104.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 122 stores software code for execution by the processor 120 in implementing portions of the functionality of image processor 102, such as portions of the preprocessing layer 110-1 and the higher processing layers 110-2 and 110-3. A given such memory that stores software code for execution by a corresponding processor is an example of what is more generally referred to herein as a computer-readable medium or other type of computer program product having computer program code embodied therein, and may comprise, for example, electronic memory such as random access memory (RAM) or read-only memory (ROM), magnetic memory, optical memory, or other types of storage devices in any combination. As indicated above, the processor may comprise portions or combinations of a microprocessor, ASIC, FPGA, CPU, ALU, DSP or other image processing circuitry.

It should be apparent from the foregoing description that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

For example, in some embodiments, the image processing system 100 is implemented as a video gaming system or other type of gesture-based system that processes image streams in order to recognize user gestures. The disclosed techniques can be similarly adapted for use in a wide variety of other systems requiring a gesture-based human-machine interface, and can also be applied to applications other than gesture recognition, such as machine vision systems in robotics and other industrial applications.

The operation of the image processor 102 will now be described in greater detail in conjunction with the diagrams of FIGS. 2 and 3.

Referring initially to FIG. 2, a portion 200 of the image processor 102 comprises preprocessing layer 110-1 and second and third higher processing layers 110-2 and 110-3, also referred to as Layer 1, Layer 2 and Layer 3, respectively. The preprocessing layer 110-1 is coupled to the third processing layer 110-3 via first and second image data channels 111 and 112, which are arranged in parallel with one another and carry reliable partial depth information and preprocessed image frames, respectively.

The preprocessing layer 110-1 is also coupled to the second processing layer 110-2 via a bidirectional interface 114. In addition, the second processing layer 110-2 interacts with the third processing layer 110-3 as indicated.

The preprocessing layer 110-1 in this embodiment comprises a data extraction module 202 configured to separate the reliable partial depth information from other depth information of received raw image data, and a raw data preprocessing module 204 configured to generate the complete preprocessed frames. These modules have respective inputs coupled to a source of the received raw image data, which is assumed in this embodiment to comprise a sensor of a depth imager, and respective outputs coupled via the respective first and second data channels 111 and 112 to the third processing layer 110-3.

The raw image data from the sensor may include a stream of frames comprising respective depth images, with each such depth image comprising a plurality of depth image pixels. For example, a given depth image D may be provided to the preprocessing layer 110-1 in a form of matrix of real values. Each such real value may more particularly provide a depth value dᵢⱼ for a particular pixel of the depth image, where i and j denote pixel indices, and the depth value represents distance to an imaged object. A given such depth image is also referred to herein as a depth map.

A given pixel with indexes i, j and a depth value dᵢⱼ can be transformed to (x, y, z) coordinates in 3D space. Also, if the depth is unknown for a given pixel, a predefined value u (e.g., zero) may be used as the depth value for that pixel. A wide variety of other types of image data may be used in other embodiments.

In some embodiments, a sensor that generates the depth values for the pixels may also provide corresponding reliability values for those pixels. For example, each pixel (i, j) supplied by a sensor of that type may comprise a pair (dᵢⱼ, rᵢⱼ) where 0≦rᵢⱼ≦1 is a depth image pixel reliability indicator or other type of reliability value. Alternatively, the reliability values may be estimated or otherwise determined in the preprocessing layer 110-1 based on known characteristics of the particular type of sensor. The reliability values may be part of a separate reliability matrix, as will be described below in conjunction with FIG. 3. Numerous other techniques may be used to provide indications of the reliability associated with particular pixels or other portions of a depth image. Such determinations may be carried out at least in part within the preprocessing layer 110-1, or in other system elements.

The second processing layer 110-2 in this embodiment implements a plurality of low-level image processing primitives, particular examples of which will be described in greater detail below in conjunction with FIG. 3. It should also be noted that such low-level image processing primitives may comprise one or more hardware-accelerated recognition primitives selected from a primitives library associated with the second processing layer, as in the embodiment of FIG. 4.

The third processing layer 110-3 in this embodiment implements high-level application-specific image processing, which is assumed to comprise at least gesture recognition (GR), but could additionally or alternatively comprise other types of high-level application-specific image processing such as activity recognition, emotion recognition and gaze tracking. The third processing layer 110-3 more particularly comprises a first processing module 206 adapted to receive the reliable partial depth information carried over the first image data channel 111, and a second processing module 208 adapted to receive coupled the complete preprocessed frames carried over the second image data channel 112. The first and second processing modules 206 and 208 are more particularly comprise respective reliable data processing and renovated data processing modules, the operation of which will be described in greater detail in conjunction with FIG. 3.

A data combining and processing module 210 is coupled to the first and second processing modules 206 and 208 and configured to combine at least portions of the partial depth information and the complete preprocessed frames for subsequent processing. In this embodiment, the subsequent processing, which may be implemented in additional higher processing layers of the image processor 102 or in another processing device, comprises at least one GR application that utilizes GR output of the third processing layer 110-3 in the form of a parametric representation of an imaged scene. Other types of processed image data outputs may be provided to one or more application layers of the image processor 102 or a related processing device 106 or destination 107.

With reference now to FIG. 3, the portion 200 of the image processor 102 is illustrated in greater detail. This figure also shows preprocessing layer 110-1 coupled to second and third processing layers 110-2 and 110-3, including modules 202 and 204 of the preprocessing layer 110-1 and modules 206, 208 and 210 of the third processing layer 110-3. Again, the layers 110-1, 110-2 and 110-3 are more particularly denoted as Layer 1, Layer 2 and Layer 3. The modules 202, 204, 206 and 208 of Layer 1 and Layer 2 are also denoted as processing blocks 1.1, 1.2, 3.1 and 3.2, respectively.

The processing block 3.1 is configured for processing reliable data received from the processing block 1.1 of preprocessing layer 110-1 via the first image data channel 111, denoted Channel 1 in this figure. In this embodiment, processing block 3.1 includes block 3.1.1 in which objects are detected based on models, and block 3.1.2 in which scenes are segmented, both of which may be implemented using well-known conventional techniques.

The processing block 3.2 is configured for processing renovated data received from the processing block 1.2 of preprocessing layer 110-1 via the second image data channel 112, denoted Channel 2 in the figure. In this embodiment, processing block 3.2 includes block 3.2.1 in which object geometric parameters such as center of mass are determined, and block 3.2.2 in which object edges and size are determined, again both of which may be implemented using well-known conventional techniques.

The data combining and processing module 210 is more particularly shown in FIG. 3 as comprising separate data combining and processing modules 210A and 210B, denoted as processing blocks 3.3 and 3.4, respectively.

In addition to blocks 1.1 and 1.2, the preprocessing layer 110-1 in this embodiment comprises processing blocks 1.3, 1.4, 1.5 and 1.6, configured for estimating pixel reliability, detecting edges, detecting reflections, and performing inter-frame registration, respectively. The various processing blocks of the processing layer 110-1 in the present embodiment will now be described in greater detail.

1.1 Extract Reliable Data

This block receives raw image data comprising a depth image D and extracts highly reliable depth information using additional information provided by blocks 1.3, 1.4 and 1.5. The resulting reliable partial depth information is carried over Channel 1 of the multi-channel interface to processing layer 110-3,

1.1.1 Exclude Pixels with Low Reliability

This block receives depth image D and a corresponding reliability matrix R from block 1.3, and generates a first modified depth image D′=∥d′ᵢⱼ∥ in which each pixel has either a reliable depth value or an unknown depth value. For example, the pixels of the first modified depth image may be computed as follows:

$${d}_{ij}^{′} = \{ \begin{matrix}{d}_{ij} & {r}_{ij} \geq reliablility\_threshold \\ u & otherwise\end{matrix}$$

where u is a particular predetermined value indicative of unknown depth, such as a value of zero.

1.1.2 Exclude Pixels Near Edges of Close Objects

This block receives the first modified depth image D′ and a corresponding edge matrix E from block 1.4, and generates a second modified depth image D″=∥d″ᵢⱼ∥ which excludes pixels near edges of close objects. For example, the pixels of the second modified depth image may be computed as follows:

$${d}_{ij}^{″} = \{ \begin{matrix}{d}_{ij}^{′} & f ( E , i , j ) \geq closeness\_threshold \\ u & otherwise\end{matrix}$$

where u is again the above-noted predetermined value indicative of unknown depth and f(E, i, j) is a function that provides a value of closeness for one or more objects in an area surrounding the pixel (i, j).

1.1.3 Exclude Pixels Related to Reflections

This block receives the second modified depth image D″ and a corresponding reflection matrix M from block 1.5, and generates a third modified depth image D′″=∥d′″ᵢⱼ∥ which further excludes pixels related to reflections. For example, the pixels of the third modified depth image may be computed as follows:

$${d}_{ij}^{′′′} = \{ \begin{matrix}{d}_{ij}^{″} & {m}_{ij} = 0 \\ u & {m}_{ij} > 0\end{matrix}$$

where u is again the above-noted predetermined value indicative of unknown depth, and where mᵢⱼ>0 if the pixel (i, j) belongs to an area treated as a reflection, and has a value of zero otherwise. The third modified depth image in this embodiment represents the reliable partial depth information that is transmitted over Channel 1 of the multi-channel interface to the third processing layer 110-3. Other types of reliable partial depth information may be used in other embodiments. For example, only a subset of blocks 1.1.1, 1.1.2 and 1.1.3, such as only a particular one of these blocks, may be utilized in other embodiments. A wide variety of alternative techniques may be used to identify reliable depth information from a given depth image. The term “partial depth information” as used herein is therefore intended to he broadly construed.

1.2 Raw Data Preprocessing

This block receives raw image data comprising depth image D and preprocesses the depth image to provide a corresponding preprocessed image frame using additional information provided by blocks 1.3, 1.4, 1.5 and 1.6. The resulting complete preprocessed image frame is carried over Channel 2 of the multi-channel interface to processing layer 110-3.

1.2.1 Remove Defects in Depth Image Based on Intraframe Information This block receives depth image D and generates depth image \tilde{D} from which defects have been removed utilizing intraframe information such as reliability matrix R from block 1.3, edge matrix E from block 1.4, and reflection matrix M from block 1.5. Objects which are observed in the depth image D typically have surfaces, i.e., areas in which neighboring pixels have closely similar depth values: |dᵢⱼ−d_{i+1,j}|<h and |dᵢⱼ−d_{i,j+1}|<h for any i, j in some area A where h denotes a defect detection threshold. There are various types of defects in such surfaces which may result from noise and other technical or physical characteristics of the sensor. The threshold h is typically specified as larger than a depth difference that would ordinarily be produced by noise alone. Block 1.2.1 is configured to detect defects that cause depth differences that exceed the specified threshold h.

By way of example, a given defect may be defined as a “hole” in a surface, or more particularly as a limited area in which depth values differ significantly from depth values of surrounding areas, where the depth value difference across the boundary of the area is abrupt and opposite sides of the area have similar depth values.

An exemplary process will now be described for locating and removing at least part of a hole in a surface of the depth image. This process operates using only a single row of depth image pixels at a time, but may additionally or alternatively be implemented, for example, using a single column of depth image pixels at a time, or using single lines of diagonal depth image pixels at a time. Combinations of such arrangements may be used in order to enhance the quality of the defect removal process.

The process to be described utilizes an edge matrix E which in this context more particularly comprises a list of elements eₖ=(iₖ,jₖ,dₖ,cₖ) where iₖ,jₖ,d_{,} denote indexed position and depth value of a corresponding pixel k, and cₖ denotes the direction of depth change for that pixel. These elements of the list E are also referred to below as candidate border pixels.

The defect detection threshold h in this process more particularly specifies a minimum depth to the bottom of a hole. Other input parameters for the exemplary process include the following:

hole_size—maximum size hole that is considered removable;

border_dist_diff—maximum depth difference on opposite sides of a hole; and

border_dist_change—maximum depth change per pixel.

The process includes the following steps 1 through 3:

1. Fill in the list E of candidate border pixels using the rules given below. This part of the process is assumed to be performed in the edge detection block 1.4. The particular rules used to select depth image pixels as candidate border pixels may vary depending on factors such as input data quality and required selectivity. In the present embodiment, the following two candidate border pixel selection rules are utilized:

If a pixel (i, j) is such that d_{i,j+1}−dᵢⱼ≧h then it is a candidate border pixel of a left border. Do the following: set iₖ=i, jₖ=j, dₖ=dᵢⱼ and cₖ=0, add eₖ=(iₖ, jₖ, dₖ, cₖ) to the list E, increment k.

If a pixel (i, j) is such that d_{i,j-1}−dᵢⱼ≧h then it is a candidate border pixel of a right border. Do the following: set iₖ=i, jₖ=j, dₖ=d_{ij.} and cₖ=1, add eₖ=(iₖ, ,jₖ, dₖ, cₖ) to the list E, increment k.

2. Filter out left and right border pairs from the list E that satisfy the constraints of hole definition. As noted above, eₖ=(iₖ, jₖ, dₖ, cₖ) is element k of the list E . In the present embodiment, it is assumed that a pair (eₖ, eₖ₊₁) of two subsequent elements from E forms a border pair of a hole in the row i if the following constraints are satisfied:

(a) The elements are the left and the right border: cₖ=0 and cₖ₊₁=1;

(b) The elements are from the row i:iₖ=iₖ₊₁;

(c) The hole has limited size: jₖ₊₁−jₖ<hole_size;

(d) The opposite sides of the hole have similar depth: |dₖ₋₁−dₖ|<border_dist_diff; and

(e) A difference between the depth of the opposite sides of the hole satisfy:

$$\frac{\vert {d}_{k + 1} - {d}_{k} \vert}{{j}_{k + 1} - {j}_{k}} < border\_dist \_change$$

If all the constraints (a) through (e) arc satisfied for the pair (eₖ, eₖ₊₁), the next step of the process is performed.

3. Repair the hole by filling the gap between the two border pixels selected in step 2. This may involve, for example, any of a number of different types of interpolation. As a more particular example, the following linear interpolation may be used:

$$a = \frac{{d}_{k + 1} - {d}_{k}}{{j}_{k + 1} - {j}_{k}}$$

$$b = {d}_{k} - a \cdot {j}_{k}$$

$${\tilde{d}}_{ij} = a \cdot j + b$$

where j takes on values from jₖ to jₖ₊₁ and row index i is fixed.

As indicated previously, the exemplary process described above removes defects one row at a time. It can be modified in a straightforward manner to remove defects one column at a time, or one diagonal line at a time, or using combinations of row, column and line-based implementations. Such arrangements can remove a large variety of different types of depth image defects.

As one example of a combined approach utilizing both rows and columns, let V denote a result of application of the process to rows of the depth image D , let W denote a result of application of the process to columns of the depth image D, and let vᵢⱼ, wᵢⱼ denote elements of the corresponding matrixes.

The combined result \tilde{D} comprising elements \tilde{d}ᵢⱼ may be determined from V and W in different ways, such as using a minimal distance selection approach in which \tilde{d}ᵢⱼ=min(vᵢⱼ, wᵢⱼ), or using an averaging approach in which \tilde{d}ᵢⱼ=½(vᵢⱼ+wᵢⱼ). The minimal distance selection approach has been found to achieve better results than the averaging approach in certain typical applications.

In other embodiments, the exemplary process described above can be modified to classify defects in other ways, such as by depth change direction and by border type. For example, classification by depth change direction may use holes and peaks, and classification by border type may use bounded holes and unbounded holes. The classification by depth change direction can be implemented by changing holes to peaks and back by altering the direction of the depth axis d: \hat{d}ᵢⱼ=−dᵢⱼ. The classification by border type allows for the identification of gaps that are completely surrounded by pixels classified as border pixels as well as other gaps that are not completely surrounded by pixels classified as border pixels.

It should be noted that the process parameters should be selected to ensure that natural gaps within imaged objects are not inadvertently removed as defects. For example, such natural gaps are often observed between fingers of a hand. To avoid inadvertent removal of these and other natural gaps in the depth image, the process parameters may be adjusted at least in part based on feedback from higher processing layers.

As one example of such feedback, the third processing layer 110-3 may be configured to identify to the preprocessing block 110-1 one or more areas of the depth image that contain particular types of detected objects, such as hands, that are known to include natural gaps. A given such area, which could be identified using a bounding rectangle or other shape, could then be excluded from the defect removal process, or could be processed using a different set of parameters than other areas of the image.

The exemplary process for defect removal based on intraframe information described above is simple, and can be performed in parallel on multiple rows, columns or other lines of pixels of the depth image. However, in other embodiments alternative techniques can be used to remove defects based on intraframe information.

1.2.2 Remove Defects in Depth Map Based on Interframe Information

This block receives multiple processed depth images \tilde{D} from which defects have been removed based on intraframe information, and generates a modified depth image \tilde{D} from which additional defects are removed based on interframe information. For example, it may utilize first and second processed depth images \tilde{D}₁ and \tilde{D}₂, where \tilde{D}₂ is a processed depth image corresponding to a current frame and \tilde{D}₁ is a processed depth image corresponding to a past frame, such as the immediately preceding frame.

Additional inputs received in this block primarily include interframe registration information F from block 1.6, and may possibly further include edge matrix E from block 1.4 and reflection matrix M from block 1.5.

An exemplary process for removal of defects based on interframe information includes the following steps 1 through 6:

1. Perform matched segmentation of depth images \tilde{D}₁ and \tilde{D}₂ in order to identify pairs of corresponding segments. This may additionally or alternatively involve obtaining a segment list from the interframe registration information F.

For each pair of corresponding segments identified in step 1, repeat steps 2-6:

2. Apply an isometric transform to depth data in the \tilde{D}₁ segment of the pair.

3. Perform a rendering of the transformed depth data of the \tilde{D}₁, segment to match a coordinate grid of the \tilde{D}₂ segment of the pair.

4. For each pixel in the \tilde{D}₂ segment having the unknown depth value u, if the rendered segment from \tilde{D}₁ contains an actual depth value for this pixel, replace the unknown depth value u with the actual depth value.

5. Fill any small residual gaps in the resulting \tilde{D}₂ segment using an interpolation technique.

6. Apply a smoothing transform between reconstructed and non-reconstructed pixels of the \tilde{D}₂ segment.

The above process steps, like those of the other processes described herein, are exemplary only, and additional or alternative steps may be used in other embodiments. For example, steps 5 and 6 may be eliminated in one possible alternative implementation of the above process.

1.2.3 Smoothing and Denoising

This block receives the depth image \tilde{\tilde{D}} and generates as its output a smoothed and denoised depth image {tilde over (\tilde{\tilde{D}})}. A wide variety of different techniques can be used in this block. For example, the block may implement one or more of the smoothing or denoising techniques disclosed in Russian Patent Application Attorney Docket No. L12-1843RU1, entitled “Image Processor with Edge-Preserving Noise Suppression Functionality,” which is incorporated by reference herein.

1.3 Estimate Reliability of Each Pixel This block generates the reliability matrix R described above. As mentioned previously, some types of sensors provide reliability values at their output, and for other types of sensors the reliability values may be estimated or otherwise determined in this block. Such determinations of reliability values in block 1.3 generally involves using known physical properties or other characteristics of the particular type of sensor. For example, SL sensors typically have quadric error growth as a function of depth while ToF sensors have linear error growth as a function of depth. Reliability estimations based on statistics may additionally or alternatively be used. For example, the reliability value of a given pixel may be estimated based on the difference between the depth value of that pixel and the mean depth value calculated for multiple pixels of a designated surrounding area.

1.4 Detect Edges

This block provides information about edges in the depth image D in the form of an edge matrix E . For example, in some embodiments, element eᵢⱼ of E indicates if pixel (i, j) belongs to an edge and possibly also provides additional information characterizing that edge pixel. As a more particular example, the edge matrix E may be in the form of a list of pixels belonging to edges, having elements eₖ=(iₖ, jₖ, dₖ, gₖ, hₖ) where iₖ, jₖ, dₖ denote indexed position and depth value of pixel k in the list, and gₖ, hₖ represent a corresponding gradient vector. The edge matrix E is typically more useful if it is a sparse matrix.

Any of a wide variety of edge detection techniques may be applied to generate the edge matrix E. One such technique is described above in the context of step 1 of the exemplary defect removal process of block 1.2.1.

Other examples of edge detection techniques that may be applied in embodiments of the invention are disclosed in, for example, J. Canny, “A computational approach to edge detection,” IEEE Transactions on Pattern Analysis and Machine Intelligence, Vol. PAMI-8, Issue 6, pp. 679-698, November 1986; R. Kimmel and A. M. Bruckstein, “On regularized Laplacian zero crossings and other optimal edge integrators,” International Journal of Computer Vision, 53(3):225-243, 2003; and W. K. Pratt, Digital Image Processing, 3^{rd} Edition, John Wiley & Sons, 2001, which are incorporated by reference herein. In applying a given edge detection operation in block 1.4, any associated edge detection threshold should be set sufficiently low so as to ensure retention of important edges, as the subsequent processing to be described will ensure rejection of unreliable edges. Also, different types of edge detection operations, potentially using different edge detection thresholds and other parameters, may be used for different types of input raw image data in block 1.4

It should be noted that the term “edge matrix” as used herein is intended to be broadly construed, and in the context of block 1.4 may comprise, for example, an edge map, edge image or other set of pixel information characterizing detected edges. The term “edge” is also intended to be broadly construed, so as to encompass, for example, a set of pixels in a given image that are associated with a transition between part of a periphery of an imaged object and other portions of the image. In a given edge matrix E, edge pixels may be indicated with particular binary pixel values. Thus, a pixel that is part of an edge has a binary value of “1” in the edge matrix while another pixel that is not part of an edge has a binary value of “0” in the edge matrix. The terms “white” and “black” may also be used herein to denote respective edge and non-edge pixels of an edge matrix. As indicated above, such an edge matrix may also be referred to herein as an edge map or an edge image.

The edge detection techniques applied in block 1.4 may involve techniques such as rejection of undersized edges, as well as various types of edge segmentation. For example, edge segmentation may be used to identify a plurality of distinct edge segments, where each pixel of a given edge segment corresponds to a particular pixel of an edge matrix and all edges are assumed to be one pixel thick. Each such edge segment has a starting pixel and an ending pixel, and may include filled or non-filled corner positions, or combinations thereof. Numerous other types of edge segments may be generated in block 1.4. For example, edge segments in other embodiments may be more than one pixel in thickness.

1.5 Detect Reflections

As mentioned above, reflections are manifested as unexpected changes of depth value. For example, the depth value in a given area of the depth image D may be falsely decreased as a result of reflection from a shiny object. This block receives the input depth image D and generates the previously-described reflection matrix M providing information on reflections. For example, the reflection matrix M may be configured such that element mᵢⱼ=\tilde{d}ᵢⱼ if the pixel (i, j) belongs to an area treated as a reflection, and is zero otherwise, where the value \tilde{d}ᵢⱼ>0 is an estimation of real depth value for the pixel (i, j).

An exemplary process for detecting reflections in block 1.5 is similar to the process used to remove defects in block 1.2.1. More particularly, the interpolated depth values d\tilde{d}ᵢⱼ calculated in step 3 of that process may be used to fill in the pixels of reflection areas in the matrix M . The difference between these two different contexts is that defects detected in block 1.2.1 are holes, or areas in which depth is falsely increased, while reflections are peaks, or areas in which depth is falsely decreased. However, peaks can be easily transformed to holes and vice versa, as indicated previously herein, by altering the direction of the depth axis d: \hat{d}ᵢⱼ=−dᵢⱼ. As a more particular example, one can transform peaks determined in block 1.5 to holes for use in block 1.2.1 by providing c−dᵢⱼ depth values to the input of block 1.2.1, where c is a constant selected such that

$$c > {max}_{ij} {d}_{ij} .$$

1.6 Interframe Registration

This block receives two depth images D₁ and D₂ corresponding to two different frames of an input image stream and outputs interframe registration information F which indicates correspondence between the two depth images. For example, in one embodiment, the frame registration data is given by F={(A₁,dᵢ), i=1 . . . N_{F}} where each A, is a 3x3 orthogonal transform matrix providing a 3D space rotation, and each dᵢ, is a real vector of size 3. Such a pair (Aᵢ,dᵢ) describes the isometric transform of a segment of D₁ such that, if F is applied to this segment of D₁, then its pixels become close to the pixels of the corresponding segment of D₂, in a designated sense such as Euclidian distance between rendered depth images.

An exemplary process for interframe registration in block 1.6 includes the following steps 1 through 5:

1. Perform matched segmentation of depth images D₁ and D₂ in order to identify pairs of corresponding segments. This step may be viewed as separating an image into objects, and may be skipped if the images are assumed to include only a single segment. The list of segments may be included as part of the frame registration information F.

For each pair of corresponding segments, perform steps 2-5:

2. Detect feature points P₂={p₁, p₂, . . . , p_{N}_{₂}}, pᵢ∈κ³ in the D₂ segment of the pair.

3. Using correlation analysis or another type of feature detection that is invariant to affine and isometric transforms, find prototypes P₁={p′₁, P′₂, . . . , p′_{N}_{₂}}, p′ᵢ∈κ³ on feature points in the D₁ segment of the pair. If for some feature point in set P₁ a prototype is not found, that feature point may be excluded from the set P₁.

4. Solve an over-determined system of linear equations for sets P₁ and P₂ to find the best pair {A,d} defining an isometric transform of the D₁ segment to best fit the corresponding D₂ segment. Solution of the system of linear equations may involve use of a least mean squares technique or other known technique.

5. Exclude from sets P₁ and P₂ any outlying points that do not meet a specified threshold when applying isometric transform {A,d} and repeat step 4.

Again, these steps are exemplary only, and additional or alternative steps may be used in other embodiments. For example, steps 1 and 5 may be eliminated in one possible alternative implementation of the above process.

The various processes described above in the context of particular processing blocks of portion 200 of image processor 102 as illustrated in FIG. 3 can be pipelined in a straightforward manner. For example, at least a portion of the steps of a given process can typically be performed in parallel with one another, thereby reducing the overall latency of the process, and facilitating implementation of the described techniques in real-time image processing applications. Also, the particular processing layers and blocks and their interconnection as illustrated in FIG. 3 should therefore be viewed as one possible arrangement of such elements in one embodiment, and other embodiments may include additional or alternative arrangements of processing layers and blocks.

As indicated in FIG. 3, the output of the processing layer 110-3 in this embodiment is supplied to a GR application for further processing, possibly in the form of a scene parametric representation. The GR application may be running on the image processor 102 or on another processing device 106 or image destination 107, as mentioned previously. Numerous other types of processing layer outputs and higher-level applications may be used in other embodiments of the image processor 102.

Accordingly, it is to be appreciated that the particular processing modules, blocks and steps used in the embodiments of FIGS. 2 and 3 are exemplary only, and other embodiments can utilize different types and arrangements of image processing circuitry and associated image processing operations. Embodiments of the invention provide particularly efficient techniques for image preprocessing in image processor 102 in a manner that facilitates subsequent processing operations of higher processing layers. For example, the use of a multi-channel interface between preprocessing layer 110-1 and third processing layer 110-3 allows the latter processing layer to achieve better results, such as a lower GR error rate, than it could in an arrangement that relies on a single channel between the two layers 110-1 and 110-3.

As indicated previously, an image processor as disclosed herein may be implemented using a wide variety of different types of image processing circuitry. Another exemplary implementation of an image processing system 400 is shown in FIG. 4. In this embodiment, the image processing system 400 comprises an image processor 402 in the form of a controller chip. The image processor 402 is coupled to a set of image sources 405 that include a depth sensor 405-0 and a plurality of additional sensors 405-1 through 405-N that include, for example, a color CMOS image sensor 405-1 and a microphone array 405-N.

The depth sensor 405-0 and at least a subset of the additional sensors 405-1 through 405-N may be combined with the image processor 402 into an imager, such as a depth imager that generates and processes both depth images and 2D color images.

The image processor 402 includes a preprocessing layer 410-1 and two higher processing layers in the form of second processing layer 410-2 and third processing layer 410-3, also denoted as respective 1^{st}, 2^{nd} and 3^{rd} layers.

The preprocessing layer 410-1 includes a depth map compute module 412 that receives raw image data from the depth sensor 405-0, and additional sensor interfaces 414-1 through 414-N adapted to receive additional input sensor data from the respective additional sensors 405-1 through 405-N.

The second processing layer 410-2 comprises a hardware-accelerated recognition primitives library 415 and a plurality of sensor interaction cores 416. The sensor interaction cores provide processing relating to combinations of depth and video information, depth and audio information, and possibly others.

The third processing layer 410-3 comprises firmware 417 for various types of image processing operations, including gesture recognition, activity recognition, emotion recognition, gaze tracking, and so on. Also included in this layer is a firmware execution engine 418 for executing operations associated with the firmware 417.

The image processor 402 further includes a plurality of external interfaces 420 for communicating with other processing devices of the image processing system 400, although such other processing devices are not explicitly shown in the figure.

The depth map compute module 412, sensor interfaces 414, hardware-accelerated recognition primitives 415, sensor interaction cores 416, firmware 417, firmware execution engine 418 and external interfaces 420 are considered examples of what is more generally referred to herein as image processing circuitry.

It should again be emphasized that the embodiments of the invention as described herein are intended to be illustrative only. For example, other embodiments of the invention can be implemented utilizing a wide variety of different types and arrangements of image processing circuitry, processing layers, processing blocks, image data channels and processing operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. An image processor comprising:
image processing circuitry implementing a plurality of processing layers including a preprocessing layer for received image data and one or more higher processing layers coupled to the preprocessing layer; and
a multi-channel interface comprising at least first and second image data channels arranged in parallel with one another between the preprocessing layer and a given higher processing layer;
wherein the first image data channel is configured to carry partial depth information derived from the received image data to the given higher processing layer; and
wherein the second image data channel is configured to carry complete preprocessed frames of the received image data from the preprocessing layer to the given higher processing layer.

2. The image processor of claim 1 wherein the received image data comprises raw image data received from a depth sensor.

3. The image processor of claim 1 wherein the partial depth information comprises depth information determined in the preprocessing layer to have at least a specified level of reliability.

4. The image processor of claim 1 wherein the preprocessing layer comprises:
a data extraction module configured to separate the partial depth information from other depth information of the received image data; and
a raw data preprocessing module configured to generate the complete preprocessed frames;
wherein said modules have respective inputs coupled to a source of the received image data and respective outputs coupled via the respective first and second data channels to the given higher processing layer.

5. The image processor of claim 1 wherein the one or more higher processing layers coupled to the preprocessing layer comprise a second processing layer coupled to a third processing layer and wherein the first and second image data channels are arranged in parallel with one another between the preprocessing layer and the third processing layer.

6. The image processor of claim 5 wherein the second processing layer implements a plurality of low-level image processing primitives.

7. The image processor of claim 6 wherein the low-level image processing primitives comprise one or more hardware-accelerated recognition primitives.

8. The image processor of claim 5 wherein the third processing layer comprises:
a first processing module adapted to receive the partial depth information carried over the first image data channel;
a second processing module adapted to receive coupled the complete preprocessed frames carried over the second image data channel; and
a data combining module coupled to the first and second processing modules and configured to combine at least portions of the partial depth information and the complete preprocessed frames for subsequent processing.

9. The image processor of claim 5 wherein the third processing layer implements high-level application-specific image processing using at least one firmware execution engine.

10. The image processor of claim 9 wherein the high-level application-specific image processing comprises one or more of gesture recognition, activity recognition, emotion recognition and gaze tracking.

11. The image processor of claim 1 wherein the image processing circuitry comprises at least one graphics processor integrated circuit.

12. An integrated circuit comprising the image processor of claim 1.

13. A method comprising:
configuring a plurality of processing layers of an image processor including a preprocessing layer for received image data and one or more higher processing layers; and
communicating image data from the preprocessing layer to a given higher processing layer over a multi-channel interface comprising at least first and second image data channels;
wherein the first image data channel is configured to carry partial depth information derived from the received image data to the given higher processing layer; and
wherein the second image data channel is configured to carry complete preprocessed frames of the received image data from the preprocessing layer to the given higher processing layer.

14. The method of claim 13 wherein said configuring and communicating are implemented in at least one processing device comprising a processor coupled to a memory.

15. The method of claim 13 wherein the partial depth information comprises depth information determined in the preprocessing layer to have at least a specified level of reliability.

16. The method of claim 13 further comprising:
receiving the image data as raw image data from a depth sensor;
separating the partial depth information from other depth information of the received image data; and
generating the complete preprocessed frames from the raw image data.

17. A computer-readable storage medium having computer program code embodied therein, wherein the computer program code when executed in the processing device causes the processing device to perform the method of claim 13.

18. An image processing system comprising:
one or more image sources providing image data;
one or more image destinations; and
an image processor coupled to said one or more image sources and said one or more image destinations;
wherein the image processor comprises:
image processing circuitry implementing a plurality of processing layers including a preprocessing layer for received image data and one or more higher processing layers coupled to the preprocessing layer; and
a multi-channel interface comprising at least first and second image data channels arranged in parallel with one another between the preprocessing layer and a given higher processing layer;
wherein the first image data channel is configured to carry partial depth information derived from the received image data to the given higher processing layer; and
wherein the second image data channel is configured to carry complete preprocessed frames of the received image data from the preprocessing layer to the given higher processing layer.

19. The system of claim 18 wherein at least one of the one or more image sources comprises a depth sensor.

20. The system of claim 19 wherein the depth sensor is part of a depth imager that incorporates the image processor.
